(19) United States
(12) Patent Application Publication
(10) Pub. No.: US 2022/0087231 A1
(43) Pub. Date: Mar. 24, 2022

(54) FISH HANDLING APPARATUS AND ASSOCIATED METHOD

(71) Applicant: Zoetis Services LLC, Parsippany, NJ (US)

(72) Inventor: Johan Odd Moflag, Nesna (NO)

(21) Appl. No.: 17/482,532

(22) Filed: Sep. 23, 2021

Related U.S. Application Data
(60) Provisional application No. 63/082,622, filed on Sep. 24, 2020.

(51) Int. Cl. A01K 61/13; A61D 1/02

(52) U.S. Cl. CPC A01K 61/13; A61D 1/025

(57) ABSTRACT

A fish handling apparatus comprises a supply arrangement arranged to supply a plurality of fish and a receiving arrangement arranged to receive and distribute a single fish of the plurality of fish. A conveying device is arranged between the supply arrangement and the receiving arrangement. The conveying device is further arranged to remove the single fish from the plurality of fish received by the supply arrangement and to convey the single fish to the receiving arrangement. A suction system is operably engaged with the conveying device and is arranged to apply suction to the single fish via the conveying device so as to attract the single fish into engagement with the conveying device. An associated method is also provided.

### CROSS REFERENCE TO RELATED APPLICATION

This application claims the benefit of U.S. Provisional Patent Application No. 63/082,622, filed Sep. 24, 2020, which is expressly incorporated herein by reference in its entirety.

### BACKGROUND

### Field of the Disclosure

Aspects of the present disclosure relates to fish processing and, more particularly, to a fish handling apparatus and associated method.

### Description of Related Art

Vaccination of live fish is performed completely manually or using semi-automatic or fully automatic machines. Operators inject a vaccine into each individual fish using a vaccination syringe or feed fish into a semi-automatic vaccination machine in a predetermined orientation. In the instance of fully automatic machines, the fish must be sorted, singulated, and oriented upstream of an automated vaccination device such that each individual fish is appropriately oriented and accessible for the targeted injection. Unfortunately, current upstream singulating provisions are physically challenging to the live fish and may also require a large footprint in the fish hatchery.

Accordingly, it would be desirable to provide a fish handling system capable of singulating the fish, preferably in parallel channels, such that less physical stress is demanded on the live fish, while reducing the overall footprint of the fish processing system. Furthermore, it would be desirable to provide associated methods to improve live fish processing and handling in the hatchery, particularly to provide an even and predictable flow and feeding pattern of the individual fish to the automated vaccination device.

### SUMMARY

The above and other needs are met by aspects of the present disclosure which, in one aspect, provides a fish handling apparatus, comprising a supply arrangement arranged to supply a plurality of fish and a receiving arrangement arranged to receive a single fish of the plurality of fish and to distribute the single fish therefrom. A conveying device is arranged between the supply arrangement and the receiving arrangement, wherein the conveying device is further arranged to remove the single fish from the plurality of fish at the supply arrangement and to convey the single fish to the receiving arrangement. A suction system is operably engaged with the conveying device and is arranged to apply suction to the single fish via the conveying device so as to attract the single fish into engagement with the conveying device.

Another aspect provides a fish handling method, comprising receiving a plurality of fish at a supply arrangement and receiving a single fish of the plurality of fish at a receiving arrangement for further distribution. The single fish is removed from the plurality of fish received by the supply arrangement, with a conveying device arranged between the supply arrangement and the receiving arrangement, and the single fish conveyed to the receiving arrangement. Suction is applied to the single fish via the conveying device, with a suction system engaged therewith, so as to attract the single fish into engagement with the conveying device.

The present disclosure thus includes, without limitation, the following example embodiments:

Example Embodiment 1: A fish handling apparatus, comprising a supply arrangement arranged to supply a plurality of fish; a receiving arrangement arranged to receive a single fish of the plurality of fish and to distribute the single fish therefrom; a conveying device arranged between the supply arrangement and the receiving arrangement, the conveying device being further arranged to remove the single fish from the plurality of fish at the supply arrangement and to convey the single fish to the receiving arrangement; and a suction system operably engaged with the conveying device and arranged to apply suction to the single fish via the conveying device so as to attract the single fish into engagement with the conveying device.

Example Embodiment 2: The apparatus of any preceding example embodiment, or combinations thereof, wherein the conveying device comprises a hollow cylindrical wall forming a drum defining an axis extending axially therethrough, the drum being rotatable about the axis, and the cylindrical wall defining one or more suction ports extending therethrough.

Example Embodiment 3: The apparatus of any preceding example embodiment, or combinations thereof, wherein the suction system is arranged in fluid communication with the one or more suction ports via an inner chamber defined by the hollow cylindrical wall.

Example Embodiment 4: The apparatus of any preceding example embodiment, or combinations thereof, comprising a plenum disposed within the hollow cylindrical wall and defining a plenum outlet disposed adjacent thereto, the plenum outlet extending angularly from an interaction between the supply arrangement and the conveying device toward an interaction between the conveying device and the receiving arrangement, the suction system being arranged in fluid communication with the plenum to apply the suction through the plenum outlet.

Example Embodiment 5: The apparatus of any preceding example embodiment, or combinations thereof, wherein the cylindrical wall defines one or more grooves extending about the axis, and wherein the one or more suction ports are defined within the one or more grooves.

Example Embodiment 6: The apparatus of any preceding example embodiment, or combinations thereof, comprising a chute associated with the receiving arrangement, the chute being arranged to extend into one of the one or more grooves to facilitate transfer of the single fish from the conveying device to the receiving arrangement.

Example Embodiment 7: The apparatus of any preceding example embodiment, or combinations thereof, wherein the supply arrangement is arranged to direct the plurality of fish into engagement with the conveying device, and wherein the conveying device is arranged such that a suction applied via the conveying device selects and attracts the single fish into engagement therewith.

Example Embodiment 8: The apparatus of any preceding example embodiment, or combinations thereof, wherein the conveying device is arranged to be movable between a receiving position and a disposing position, wherein the single fish is attracted into engagement with the conveying device by the suction at the receiving position, and wherein the conveying device is arranged such that the suction is discontinued at or before the disposing position so as to release the single fish from engagement with the conveying device to the receiving arrangement.

Example Embodiment 9: The apparatus of any preceding example embodiment, or combinations thereof, comprising one or more partitions associated with the supply arrangement and defining one or more supply channels therebetween, each supply channel extending toward the conveying device and arranged to receive the plurality of fish.

Example Embodiment 10: The apparatus of any preceding example embodiment, or combinations thereof, comprising one or more partitions associated with the conveying device and defining one or more conveying channels therebetween, each conveying channel extending from an interaction between the supply arrangement and the conveying device to an interaction between the conveying device and the receiving arrangement, and arranged to receive the single fish from a corresponding one of the supply channels.

Example Embodiment 11: The apparatus of any preceding example embodiment, or combinations thereof, comprising one or more partitions associated with the receiving arrangement and defining one or more distribution channels therebetween, each distribution channel extending from the conveying device and arranged to receive the single fish from a corresponding one of the conveying channels.

Example Embodiment 12: The apparatus of any preceding example embodiment, or combinations thereof, comprising a vaccination device arranged to receive the single fish from the receiving arrangement and to vaccinate the single fish.

Example Embodiment 13: A fish handling method, comprising receiving a plurality of fish at a supply arrangement; receiving a single fish of the plurality of fish at a receiving arrangement for further distribution; removing the single fish of the plurality of fish at the supply arrangement, with a conveying device arranged between the supply arrangement and the receiving arrangement, and conveying the single fish to the receiving arrangement; and applying suction to the single fish via the conveying device, with a suction system engaged therewith, so as to attract the single fish into engagement with the conveying device.

Example Embodiment 14: The method of any preceding example embodiment, or combinations thereof, wherein the conveying device comprises a hollow cylindrical wall forming a drum defining an axis extending axially therethrough, wherein the drum is rotatable about the axis and the cylindrical wall defines one or more suction ports extending therethrough, and wherein applying suction comprises applying the suction through the one or more suction ports of the conveying device.

Example Embodiment 15: The method of any preceding example embodiment, or combinations thereof, wherein the suction system is arranged in fluid communication with the one or more suction ports via an inner chamber defined by the hollow cylindrical wall, and wherein applying suction comprises applying the suction through the one or more suction ports by applying the suction to the inner chamber.

Example Embodiment 16: The method of any preceding example embodiment, or combinations thereof, wherein a plenum is disposed within the hollow cylindrical wall and defining a plenum outlet disposed adjacent thereto, the plenum outlet extending angularly from an interaction between the supply arrangement and the conveying device toward an interaction between the conveying device and the receiving arrangement, and wherein applying suction comprises applying the suction through the one or more suction ports by applying the suction to the plenum.

Example Embodiment 17: The method of any preceding example embodiment, or combinations thereof, wherein the cylindrical wall defines one or more grooves extending about the axis, wherein the one or more suction ports are defined within the one or more grooves, and wherein applying suction comprises applying the suction through the one or more suction ports within the one or more grooves.

Example Embodiment 18: The method of any preceding example embodiment, or combinations thereof, wherein a chute is associated with the receiving arrangement, the chute being arranged to extend into one of the one or more grooves, and wherein receiving the single fish comprises receiving the single fish in the chute from the one of the one or more grooves to facilitate transfer of the single fish from the conveying device to the receiving arrangement.

Example Embodiment 19: The method of any preceding example embodiment, or combinations thereof, wherein the supply arrangement is arranged to direct the plurality of fish into engagement with the conveying device, and wherein removing the single fish comprises removing the single fish from the plurality of fish by applying the suction via the conveying device to select and attract the single fish into engagement therewith.

Example Embodiment 20: The method of any preceding example embodiment, or combinations thereof, wherein the conveying device is arranged to be movable between a receiving position and a disposing position, wherein conveying the single fish comprises attracting the single fish into engagement with the conveying device by application of the suction at the receiving position, and discontinuing the suction at or before the disposing position so as to release the single fish from engagement with the conveying device to the receiving arrangement.

Example Embodiment 21: The method of any preceding example embodiment, or combinations thereof, wherein one or more partitions is associated with the supply arrangement and defines one or more supply channels therebetween, each supply channel extending toward the conveying device, and wherein receiving the plurality of fish comprises receiving the plurality of fish in the one or more supply channels and directing the plurality of fish along the one or more supply channels toward the conveying device.

Example Embodiment 22: The method of any preceding example embodiment, or combinations thereof, wherein one or more partitions is associated with the conveying device and defines one or more conveying channels therebetween, each conveying channel extending from an interaction between the supply arrangement and the conveying device to an interaction between the conveying device and the receiving arrangement, and wherein conveying the single fish comprises receiving the single fish in one of the one or more conveying channels from a corresponding one of the supply channels, and conveying the single fish in the one of the one or more conveying channels to the receiving arrangement.

Example Embodiment 23: The method of any preceding example embodiment, or combinations thereof, wherein one or more partitions is associated with the receiving arrangement and defines one or more distribution channels therebetween, each distribution channel extending from the conveying device, and wherein receiving the single fish comprises receiving the single fish in the one or more distribution channels from a corresponding one of the conveying channels.

Example Embodiment 24: The method of any preceding example embodiment, or combinations thereof, vaccinating the single fish received from the receiving arrangement with a vaccination device operably engaged therewith.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

It will be appreciated that the summary herein is provided merely for purposes of summarizing some example aspects so as to provide a basic understanding of the disclosure. As such, it will be appreciated that the above described example aspects are merely examples and should not be construed to narrow the scope or spirit of the disclosure in any way. It will be appreciated that the scope of the disclosure encompasses many potential aspects, some of which will be further described below, in addition to those herein summarized. Further, other aspects and advantages of such aspects disclosed herein will become apparent from the following detailed description taken in conjunction with the accompanying drawings which illustrate, by way of example, the principles of the described aspects.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates a perspective view of a fish handling apparatus according to one aspect of the present disclosure;

FIG. 2 schematically illustrates a side view of a fish handling apparatus according to one aspect of the present disclosure;

FIG. 3 schematically illustrates a side view of a fish handling apparatus according to another aspect of the present disclosure;

FIG. 4 schematically illustrates a partial side view of an interaction between a supply arrangement and a conveying arrangement of a fish handling apparatus according to one aspect of the present disclosure;

FIG. 5 schematically illustrates a plan view of a fish handling apparatus according to one aspect of the present disclosure; and

FIG. 6 schematically illustrates a fish handling method according to one aspect of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

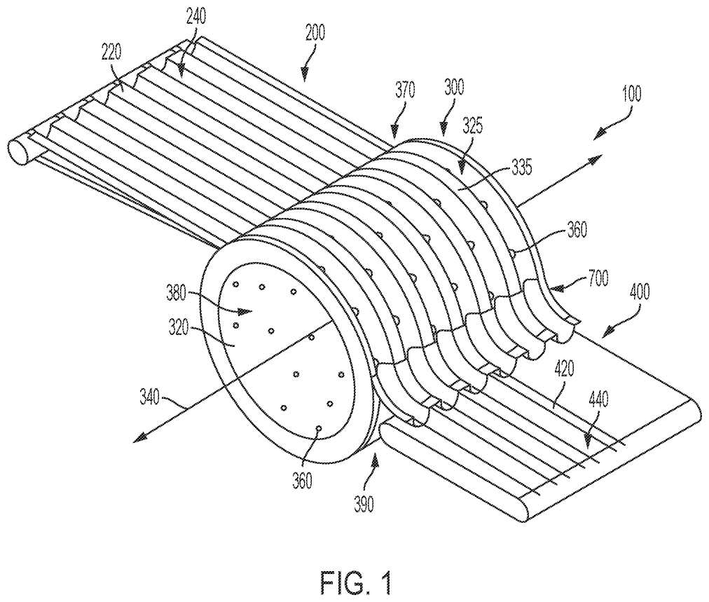

Aspects of the present disclosure are directed to a fish handling apparatus 100 (see, e.g., FIG. 1) for handling and singulating fish, particularly live fish, in a fully automated or semi-automated fish processing system. In particular aspects, the fish handling apparatus 100 is configured and arranged to perform multiple singulations of fish commensurately or in parallel so as to provide multiple singulation channels, as further disclosed herein.

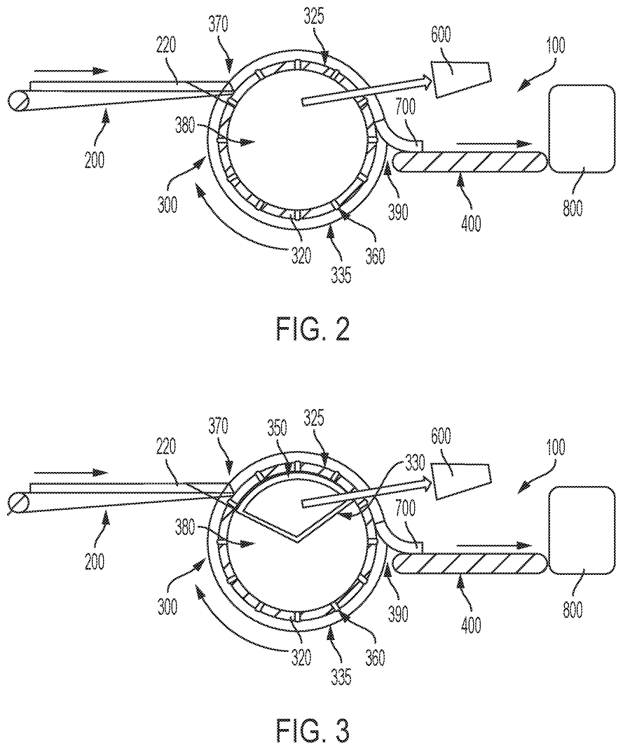

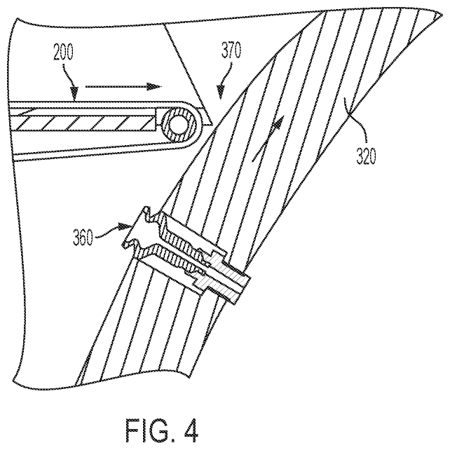

The fish handling apparatus 100, in some examples, comprises a supply arrangement 200 arranged to receive a plurality of fish and to supply the fish to a conveying device 300. A receiving arrangement 400 is arranged to receive, from the conveyor device 300, a single fish of the plurality of fish received from the supply arrangement 200 and to distribute the single fish therefrom, for example, to a vaccination device 800 (see, e.g., FIGS. 2 and 3). The conveying device 300 is thus arranged between the supply arrangement 200 and the receiving arrangement 400, and is further arranged to remove the single fish from the plurality of fish received by the supply arrangement 200 and to convey the single fish to the receiving arrangement 400. In doing so, a suction system 600 (see, e.g., FIGS. 2 and 3) is operably engaged with the conveying device 300, wherein the suction system 600 is arranged to apply suction to the single fish, via the conveying device 300, so as to attract the single fish into engagement with the conveying device 300.

In some aspects as shown, for example, in FIGS. 1-3, the conveying device 300 comprises a hollow cylindrical wall 320 forming a drum defining an axis 340 extending axially therethrough. The drum is rotatable about the axis 340, and the cylindrical wall 320 defining one or more suction ports 360 extending therethrough. In such aspects (see, e.g., FIG. 2), the suction system 600 is arranged in fluid communication with the one or more suction ports 360 via an inner chamber 380 defined by the hollow cylindrical wall 320.

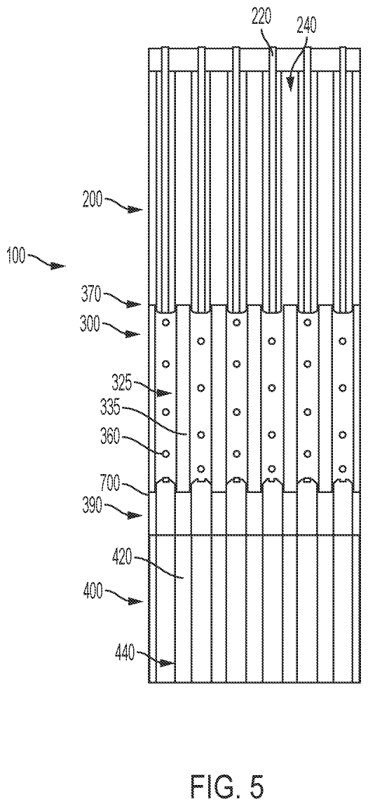

In another aspect (see, e.g., FIG. 3), a plenum 330 is disposed within the hollow cylindrical wall 320 and defines a plenum outlet 350 disposed adjacent thereto. In such instances, the plenum outlet 350 extends, for example, angularly from an interaction between the supply arrangement 200 and the conveying device 300 (e.g., a receiving position 370) toward an interaction between the conveying device 300 and the receiving arrangement 400 (e.g., a receiving position 390). In such instances, the suction system 600 is arranged in fluid communication with the plenum 330 to apply the suction through the plenum outlet 350. The conveying device 300 is arranged to be movable (e.g., rotatable) between a receiving position 370 and a disposing position 390, wherein the single fish is removed/obtained from the plurality of fish supplied by the supply arrangement 200 and is attracted into engagement with the conveying device 300 by the suction imparted via one of the suction ports 360 at the receiving position 370 (see, e.g., FIGS. 1-5). That is, the conveying device 300 is arranged such that one of the suction ports 360 is advanced to the receiving position 370 and interacts with the plurality of fish at the supply arrangement 200. The suction applied via the suction port 360 attracts one of the fish (e.g., the single fish) and at least temporarily secures the fish to the surface of the conveying device 300 (e.g., the outer surface of the drum). The single fish is thus advanced/conveyed by the conveying device 300 from the receiving position 370 to the disposing position 390. The conveying device 300 is further arranged such that the suction is discontinued at or before the disposing position 390, and the single fish is thus released from engagement with the conveying device 300 to the receiving arrangement 400. The supply arrangement 200 is thus arranged to direct the plurality of fish into engagement with the conveying device 300, and the conveying device 300 is arranged such that a suction applied via the conveying device 300 selects and attracts the single fish from the supply arrangement 200 into engagement with the drum.

The supply arrangement 200 can be any suitable device supplying a plurality of fish to the conveyor device 300. For example, the supply arrangement 200 in some aspects is configured/arranged as a chute inclined toward the conveyor device 300, or an endless belt (e.g., conveyor belt) extending toward the conveyor device 300 (e.g., the rotating drum). As shown, for example, in FIGS. 2 and 3, the supply arrangement 200 is arranged with respect to the conveying device 300 (e.g., drum) to bring the plurality of fish into engagement with the drum at an angular position on the drum of greater than 270 degrees and less than 0 degrees/360 degrees (e.g., between 9:00 and 12:00). In this manner, there is less risk of the fish overcoming the rise of the drum through the apex at 0 degrees/360 degrees to the receiving arrangement 400, without the assistance of the suction provided by the suction system 600. In some aspects, the suction applied by the suction system 600 can be discontinued at or before the disposing position of the conveying device 300 with respect to the receiving arrangement 400. For example, in some instances, the suction can be discontinued after the apex at 0 degrees but before 90 degrees (e.g., between 12:00 and 3:00), wherein the transfer of the single fish to the receiving arrangement 400 is then facilitated by gravity (see, e.g., FIG. 3).

In some aspects, the cylindrical wall 320 defines one or more grooves 325 extending about the axis 340 of the drum, wherein the one or more suction ports 360 are defined within the one or more grooves 325. In this manner, parallel channels are provided by the conveying device 300 such that multiple channels of fish can be singulated and conveyed in a single process. As such, the fish can be processed more quickly with the increased throughput of parallel channels, thereby resulting in less physical stress on the live fish, while reducing the overall footprint of the fish processing system. In some aspects, the one or more grooves 325 can be configured with a generally concave or “U” shaped cross-section, with the one or more suction ports 360 being disposed about the minima of the concavity. With the one or more grooves 325 being configured in this manner, each suction port 360 within each groove 325 is more likely to interact with an attract only the single fish, as it may be unlikely for more than one fish at a time to interact with the suction port 360 in the minima of the concavity of the respective groove 325. Moreover, the one or more suction ports 360 may be angularly spaced apart about the drum such that the successive single fish conveyed by the conveying device 300 are conveyed at even and predictable intervals. In addition, the one or more suction ports 360 in adjacent grooves 325 may be corresponding (e.g., aligned in parallel with the axis 340) or angularly offset with respect to each other. In either instance, the one or more suction ports 360 can be arranged in the respective grooves 325 so as to provide an even and predictable pattern of the fish conveyed by the grooves 325 of the conveying device 300.

In some aspects, the formation of the one or more grooves 325 provides one or more partitions 335 associated with the conveying device 300 (e.g., such that the one or more grooves or conveying channels 325 is defined between the one or more partitions 335). Each groove/conveying channel 325 extends from an interaction between the supply arrangement 200 and the conveying device 300 (e.g., the receiving position) to an interaction between the conveying device 300 and the receiving arrangement 400 (e.g., the disposing position). One skilled in the art will appreciate, however, that the drum (e.g., conveying device 300) can be configured/arranged in different manners. For example, the cylindrical wall 320 can be formed without the grooves (e.g., as a right cylinder) and separate rings (not shown) can be disposed about and axially spaced apart with respect to each other such that the one or more grooves 325 is defined between adjacent rings.

With the conveying device 300 configured/arranged to define multiple channels, one or more partitions 220 can also be associated with the supply arrangement 200 so as to define one or more supply channels 240 therebetween. The number of the one or more supply channels 240 generally corresponds to the number of the one or more grooves 325 associated with the conveying device 300. In addition, each supply channel 240 extends toward the conveying device 300, with each supply channel 240 being arranged to receive the plurality of fish. In instances where the supply arrangement 200 comprises a conveyor (e.g., conveyor belt), the one or more partitions 220 can be affixed to the conveyor belt itself or, for example, the one or more partitions 220 can be placed adjacent to an upper surface of the conveyor to define the one or more supply channels 240. The one or more supply channels 240 thus coincide with the one or more grooves 325 such that each groove 325 is arranged to receive the single fish from a corresponding one of the supply channels 240.

In some such aspects, one or more partitions 420 are also associated with the receiving arrangement 400 so as to define one or more distribution channels 440 therebetween. The number of the one or more distribution channels 440 generally corresponds to the number of the one or more grooves 325 associated with the conveying device 300. In addition, each distribution channel 440 extends from the conveying device 300 and is arranged to receive the single fish from a corresponding one of the grooves/conveying channels 325. In instances where the receiving arrangement 400 comprises a conveyor (e.g., conveyor belt), the one or more partitions 420 can be affixed to the conveyor belt itself or, for example, the one or more partitions 420 can be placed adjacent to an upper surface of the conveyor to define the one or more distribution channels 440. The one or more distribution channels 440 thus coincide with the one or more grooves 325 such that each distribution channel 440 is arranged to receive the single fish from a corresponding one of the grooves/conveying channels 325.

In some aspects, a chute 700 can be associated with the receiving arrangement 400 and disposed about the interaction between the conveying device 300 and the receiving arrangement 400 (e.g., about the disposing position). In such instances, the chute 700 is arranged to extend into one of the one or more grooves 325 to facilitate transfer of the single fish from the conveying device 300 to the receiving arrangement 400 (e.g., the chute 700 may be arcuately configured (e.g., concave) such that the single fish is transferred along the concave arc of the chute 700 in a smooth transition to the receiving arrangement 400 and the single fish is not subject to an impact in the transition).

As previously disclosed, a processing arrangement such as, for example, a vaccination device 800 (see, e.g., FIGS. 2 and 3), can be associated with the receiving arrangement 400, and arranged to receive the single fish from the receiving arrangement 400 to vaccinate the single fish. The vaccination device 800 can be further configured/arranged to include a plurality of vaccination channels (not shown) at least correspond to the number of the one or more grooves/conveying channels 325 and/or the number of the one or more distribution channels 440.

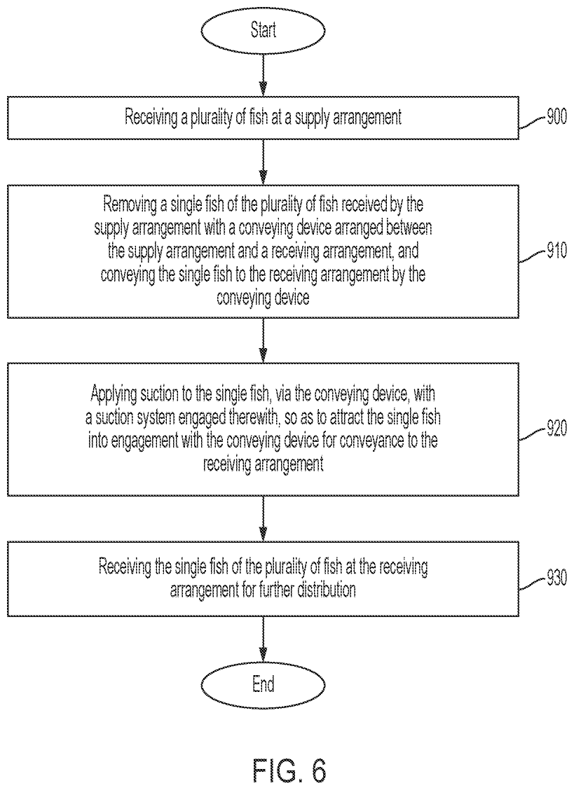

As otherwise disclosed herein, the fish handling apparatus 100 also includes a fish handling method associated therewith. One such method aspect, as shown in FIG. 6, particularly comprises a fish handling method, which includes receiving a plurality of fish at a supply arrangement (Block 900). A single fish of the plurality of fish received by the supply arrangement, is removed therefrom with a conveying device arranged between the supply arrangement and a receiving arrangement, and the single fish conveyed to the receiving arrangement by the conveying device (Block 910). Suction is applied to the single fish, via the conveying device, with a suction system engaged therewith, so as to attract the single fish into engagement with the conveying device for conveyance to the receiving arrangement (Block 920). The single fish of the plurality of fish is thus received at the receiving arrangement for further distribution (Block 930).

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

That which is claimed:

1. A fish handling apparatus, comprising:
a supply arrangement arranged to supply a plurality of fish;
a receiving arrangement arranged to receive a single fish of the plurality of fish and to distribute the single fish therefrom;
a conveying device arranged between the supply arrangement and the receiving arrangement, the conveying device being further arranged to remove the single fish from the plurality of fish at the supply arrangement and to convey the single fish to the receiving arrangement; and
a suction system operably engaged with the conveying device and arranged to apply suction to the single fish via the conveying device so as to attract the single fish into engagement with the conveying device.

2. The apparatus of claim 1, wherein the conveying device comprises a hollow cylindrical wall forming a drum defining an axis extending axially therethrough, the drum being rotatable about the axis, and the cylindrical wall defining one or more suction ports extending therethrough.

3. The apparatus of claim 2, wherein the suction system is arranged in fluid communication with the one or more suction ports via an inner chamber defined by the hollow cylindrical wall.

4. The apparatus of claim 2, comprising a plenum disposed within the hollow cylindrical wall and defining a plenum outlet disposed adjacent thereto, the plenum outlet extending angularly from an interaction between the supply arrangement and the conveying device toward an interaction between the conveying device and the receiving arrangement, the suction system being arranged in fluid communication with the plenum to apply the suction through the plenum outlet.

5. The apparatus of claim 2, wherein the cylindrical wall defines one or more grooves extending about the axis, and wherein the one or more suction ports are defined within the one or more grooves.

6. The apparatus of claim 5, comprising a chute associated with the receiving arrangement, the chute being arranged to extend into one of the one or more grooves to facilitate transfer of the single fish from the conveying device to the receiving arrangement.

7. The apparatus of claim 1, wherein the supply arrangement is arranged to direct the plurality of fish into engagement with the conveying device, and wherein the conveying device is arranged such that a suction applied via the conveying device selects and attracts the single fish into engagement therewith.

8. The apparatus of claim 7, wherein the conveying device is arranged to be movable between a receiving position and a disposing position, wherein the single fish is attracted into engagement with the conveying device by the suction at the receiving position, and wherein the conveying device is arranged such that the suction is discontinued at or before the disposing position so as to release the single fish from engagement with the conveying device to the receiving arrangement.

9. The apparatus of claim 1, comprising one or more partitions associated with the supply arrangement and defining one or more supply channels therebetween, each supply channel extending toward the conveying device and arranged to receive the plurality of fish.

10. The apparatus of claim 9, comprising one or more partitions associated with the conveying device and defining one or more conveying channels therebetween, each conveying channel extending from an interaction between the supply arrangement and the conveying device to an interaction between the conveying device and the receiving arrangement, and arranged to receive the single fish from a corresponding one of the supply channels.

11. The apparatus of claim 10, comprising one or more partitions associated with the receiving arrangement and defining one or more distribution channels therebetween, each distribution channel extending from the conveying device and arranged to receive the single fish from a corresponding one of the conveying channels.

12. The apparatus of claim 1, comprising a vaccination device arranged to receive the single fish from the receiving arrangement and to vaccinate the single fish.

13. A fish handling method, comprising:
receiving a plurality of fish at a supply arrangement;
receiving a single fish of the plurality of fish at a receiving arrangement for further distribution;
removing the single fish of the plurality of fish received by the supply arrangement, with a conveying device arranged between the supply arrangement and the receiving arrangement, and conveying the single fish to the receiving arrangement; and
applying suction to the single fish via the conveying device, with a suction system engaged therewith, so as to attract the single fish into engagement with the conveying device.

14. The method of claim 12, wherein the conveying device comprises a hollow cylindrical wall forming a drum defining an axis extending axially therethrough, wherein the drum is rotatable about the axis and the cylindrical wall defines one or more suction ports extending therethrough, and wherein applying suction comprises applying the suction through the one or more suction ports of the conveying device.

15. The method of claim 14, wherein the suction system is arranged in fluid communication with the one or more suction ports via an inner chamber defined by the hollow cylindrical wall, and wherein applying suction comprises applying the suction through the one or more suction ports by applying the suction to the inner chamber.

16. The method of claim 14, wherein a plenum is disposed within the hollow cylindrical wall and defining a plenum outlet disposed adjacent thereto, the plenum outlet extending angularly from an interaction between the supply arrangement and the conveying device toward an interaction between the conveying device and the receiving arrangement, and wherein applying suction comprises applying the suction through the one or more suction ports by applying the suction to the plenum.

17. The method of claim 14, wherein the cylindrical wall defines one or more grooves extending about the axis, wherein the one or more suction ports are defined within the one or more grooves, and wherein applying suction comprises applying the suction through the one or more suction ports within the one or more grooves.

18. The method of claim 17, wherein a chute is associated with the receiving arrangement, the chute being arranged to extend into one of the one or more grooves, and wherein receiving the single fish comprises receiving the single fish in the chute from the one of the one or more grooves to facilitate transfer of the single fish from the conveying device to the receiving arrangement.

19. The method of claim 13, wherein the supply arrangement is arranged to direct the plurality of fish into engagement with the conveying device, and wherein removing the single fish comprises removing the single fish from the plurality of fish by applying the suction via the conveying device to select and attract the single fish into engagement therewith.

20. The method of claim 19, wherein the conveying device is arranged to be movable between a receiving position and a disposing position, wherein conveying the single fish comprises attracting the single fish into engagement with the conveying device by application of the suction at the receiving position, and discontinuing the suction at or before the disposing position so as to release the single fish from engagement with the conveying device to the receiving arrangement.

21. The method of claim 13, wherein one or more partitions is associated with the supply arrangement and defines one or more supply channels therebetween, each supply channel extending toward the conveying device, and wherein receiving the plurality of fish comprises receiving the plurality of fish in the one or more supply channels and directing the plurality of fish along the one or more supply channels toward the conveying device.

22. The method of claim 21, wherein one or more partitions is associated with the conveying device and defines one or more conveying channels therebetween, each conveying channel extending from an interaction between the supply arrangement and the conveying device to an interaction between the conveying device and the receiving arrangement, and wherein conveying the single fish comprises receiving the single fish in one of the one or more conveying channels from a corresponding one of the supply channels, and conveying the single fish in the one of the one or more conveying channels to the receiving arrangement.

23. The method of claim 22, wherein one or more partitions is associated with the receiving arrangement and defines one or more distribution channels therebetween, each distribution channel extending from the conveying device, and wherein receiving the single fish comprises receiving the single fish in the one or more distribution channels from a corresponding one of the conveying channels.

24. The method of claim 13, vaccinating the single fish received from the receiving arrangement with a vaccination device operably engaged therewith.
